(19) United States
(12) Patent Application Publication
(10) Pub. No.: US 2026/0361332 A1
(43) Pub. Date: Nov. 12, 2026

(54) RADIOFREQUENCY DEVICE OF A TELECOMMUNICATIONS NETWORK

(71) Applicant: FREE MOBILE, PARIS (FR)

(72) Inventor: Bertrand Gilbert Arthur FIEVET, VERSAILLES (FR)

(21) Appl. No.: 19/670,112

(22) Filed: May 7, 2026

(30) Foreign Application Priority Data
May 9, 2025 (EP) 25305663.4

(51) Int. Cl. H04B 1/40; H01Q 1/12; H01Q 1/44

(52) U.S. Cl. CPC H04B 1/40; H01Q 1/1221; H01Q 1/125; H01Q 1/44

(57) ABSTRACT

A radiofrequency device of a telecommunications network is able to transmit and receive outdoor radiofrequency signals, is configured to be installed on a building roof, and includes at least: a radiofrequency assembly, with natural convection, including an antenna system and a radiofrequency module; an electrical power supply module for the radiofrequency assembly; and a cover transparent to electromagnetic waves forming an opaque enclosure around the radiofrequency assembly. The volume of the radiofrequency device is less than a predetermined volume threshold equal to fifteen liters and its total equivalent isotropic radiated power is greater than fifty-five dBmi.

### CROSS-REFERENCE TO RELATED APPLICATIONS

This application is a U.S. non-provisional application claiming the benefit of European Application No. 25305663.4, filed on May 9, 2025, which is incorporated herein by reference in its entirety.

### FIELD

The present invention relates to a radiofrequency device of a telecommunications network, said radiofrequency device being able to transmit and receive radiofrequency signals, configured to be installed on a building roof.

The present invention also relates to an associated radiofrequency system.

### BACKGROUND

Telecommunications needs are growing inexorably in an exponential manner.

The deployment of radio sites is a complex process for telecommunications operators.

Indeed, currently, for telecommunications operators, due to the bulk associated with current radiofrequency devices, installed outdoors (from the English outdoor), it is difficult to find new suitable and acceptable outdoor installation locations for lessors and local residents.

In other words, radio site installation currently faces technical and infrastructural constraints, notably due to urban density and the need for electrical power supply and fiber connectivity since each site needs to be connected to electricity and to a fiber-optic transmission network, which may take a long time (up to two years between the installation decision and actual commissioning), be costly, or even impossible.

Thus, in cities, there is a shortage of sites able to easily accommodate the volume and installation constraints, notably in terms of power supply and in terms of connection, of current radiofrequency devices.

In view of the growing need to densify telecommunications networks and therefore to reduce the distance between two neighboring radio sites (that is, to improve the meshing of telecommunications networks), the aim of the invention is to propose a technical solution allowing to increase the deployment of radio equipment, by simplifying the search for suitable hosting locations, while simplifying it and making it feasible in environments where it is currently impossible.

### SUMMARY

To this end, the invention has as its object a radiofrequency device of a telecommunications network, said radiofrequency device being able to transmit and receive outdoor radiofrequency signals, configured to be installed on a building roof, and comprising at least:
a radiofrequency assembly, with natural convection, comprising an antenna system and a radiofrequency module,
an electrical power supply module for said radiofrequency assembly;
a cover transparent to electromagnetic waves forming an opaque enclosure around said radiofrequency assembly,

the volume of said radiofrequency device being less than a predetermined volume threshold equal to fifteen liters and its total equivalent isotropic radiated power being greater than fifty-five dBmi.

Thus, the present invention defines a new type of compact “outdoor” radiofrequency device the volume of which is less than (or even strictly less than) fifteen liters and (cumulatively) the total equivalent isotropic radiated power of which is greater than (or even strictly greater than) fifty-five dBmi.

The radiofrequency device proposed according to the present invention is therefore both compact and high-performing, being based on a cumulative selection in volume and in total equivalent isotropic radiated power (that is, the total equivalent isotropic radiated power of the radiofrequency assembly that comprises both an antenna system and a radiofrequency module).

The selected power range and the selected volume range allow, in synergy, to obtain an operational “mini macro” type of operation, namely that the proposed sizing of the “outdoor” radiofrequency device allows easy rooftop deployment on a building, while being sufficiently powerful to limit the number of radiofrequency devices to be combined within a system so as to obtain a desired coverage. In other words, with a “mini” footprint, the present invention is able to be used to achieve the same performance as a current “macro” radio site (that is, macro-cell) of the prior art (from the English Macro time-division duplex TDD and/or frequency-division duplex FDD Radio site).

The deployment of a radio site based on the use of the radiofrequency devices proposed according to the present invention therefore allows installation on an existing infrastructure, namely a building roof.

By way of comparison, for an equivalent telecommunications application/coverage, relative to existing radio sites the present invention allows to form a radiofrequency system with equivalent performance, with, for example, a reduction in radio site weight ratio by more than 7.5 (that is, weight 7.5 times less), a reduction in output power by more than 3.5 (that is, output power 3.5 times less), a reduction in consumed power by more than 4 (that is, consumed power 4 times less), and a reduction in volume by 9 (that is, volume 9 times less).

According to other advantageous aspects of the invention, the radiofrequency device comprises one or more of the following features, taken alone or in any technically possible combinations:
said volume is contained in a cylinder 24 cm in diameter and 60 cm in height;
in which the maximum weight of said radiofrequency device is substantially equal to 12 kg;
said cover comprises at least two openings the arrangement of which one relative to the other is configured to circulate air within said enclosure;
said at least two openings are located at the vertical ends of said cover;
said radiofrequency device presents an indicator representative of the direction of its transmission beam;
said cover is configured to be secured to a building chimney stack or to a chimney or ventilation duct;
said cover is configured to substitute a building roof chimney pot;
said radiofrequency device further comprises at least one connection port configured to connect, by optical fiber, said radiofrequency assembly to a passive optical network;
said passive optical network is a fiber-to-the-home FTTH optical fiber network;
said radiofrequency device further comprises an internal GNSS module in the device.

The invention also relates to a radiofrequency system for a telecommunications network configured to be installed on a building roof comprises at least two radiofrequency devices such as described above.

According to other advantageous aspects of the invention, the radiofrequency system comprises one or more of the following features, taken alone or according to any technically possible combination:
said system comprises at least two radiofrequency devices such as described above configured to transmit in combination in a same transmission sector;
said system comprises a module configured to multiplex the signals transmitted by said at least two radiofrequency devices in the same azimuth;
said system comprises at least three radiofrequency devices such as described above configured to transmit respectively in three distinct transmission sectors.

### BRIEF DESCRIPTION OF THE DRAWINGS

The invention will appear more clearly upon reading the description that follows, given solely by way of non-limiting example, and made with reference to the drawings in which:

FIG. 1 illustrates the installation environment of a radiofrequency device of a telecommunications network according to the present invention;

FIG. 2 is an overall schematic representation of a radiofrequency device of a telecommunications network according to the present invention;

FIG. 3 is a schematic representation of an example implementation of a radiofrequency system for a telecommunications network configured to be installed on a building roof according to the present invention.

### DETAILED DESCRIPTION

In the remainder of the description, the expressions “substantially equal to” and/or “of the order of” are understood as an equality relationship within plus or minus 1 0%, in other words, with a variation of at most 10 %, and more preferably as an equality relationship within plus or minus 5 %, in other words, with a variation of at most 5 %.

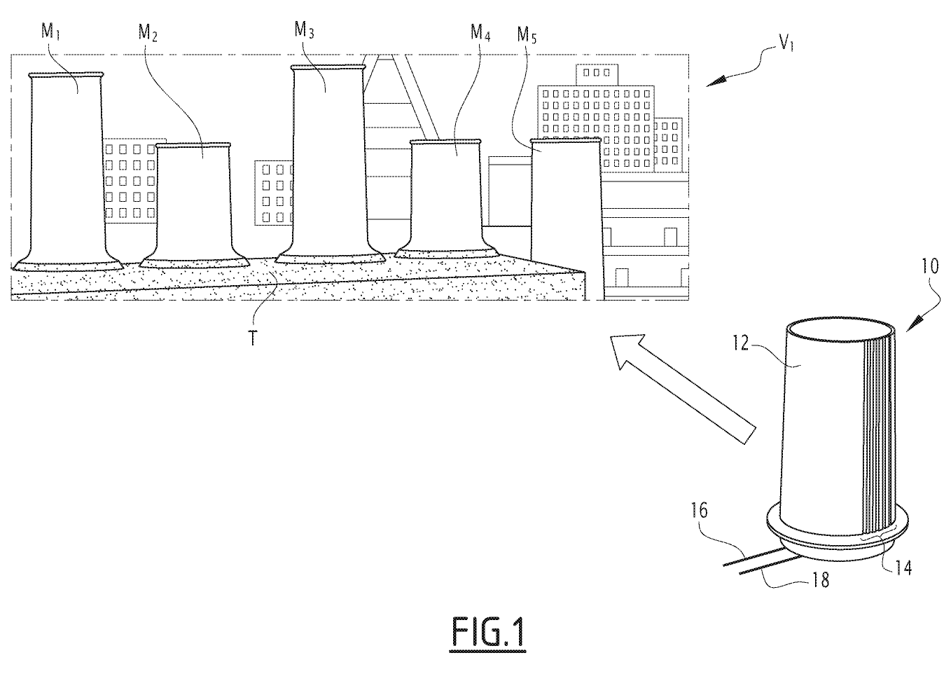

FIG. 1 illustrates an installation environment V₁of the radiofrequency device 10 of a telecommunications network according to the present invention.

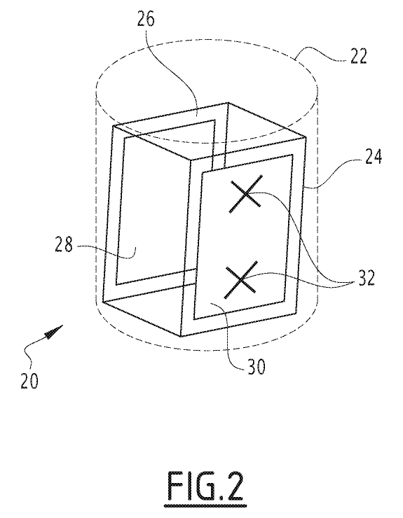

More precisely, the radiofrequency device 10 illustrated by FIG. 1 comprises a radiofrequency assembly, illustrated thereafter in relation to FIG. 2, not mechanically ventilated but with natural convection, comprising an antenna system and a radiofrequency module, an electrical power supply module for said radiofrequency assembly.

According to the present invention, the total equivalent isotropic radiated power of this assembly is greater than (or even strictly greater than) fifty-five dBmi.

In FIG. 1, said radiofrequency assembly and said electrical power supply module are concealed by a cover 12 transparent to electromagnetic waves forming an opaque enclosure around said radiofrequency assembly.

According to the example of FIG. 1, advantageously, the volume of said radiofrequency device 10 is less than (or even strictly less than) a predetermined volume threshold equal to fifteen liters.

In other words, according to the present invention it is proposed to provide a radiofrequency device which, within a size-constrained volume, is able to present a total equivalent isotropic radiated power (that is, total EIRP [dBmi]) of this assembly greater than (or even strictly greater than) fifty-five dBmi (that is, 55 dBmi minimum).

As illustrated by FIG. 1, via the selected volume less than (or even strictly less than) 15 L, the outdoor radiofrequency device 10 proposed according to the present invention is able to (that is, configured to) substitute a building roof chimney pot, which advantageously allows its quasi “natural” installation on a building roof T as illustrated by the arrow in FIG. 1, said roof furthermore comprising existing chimney pots M₁, M₂, M₃, M₄, M₅.

A roof chimney pot designates a device installed on the roof of a building, generally to ensure ventilation of flue ducts, technical shafts, or ventilation networks. Traditional chimney pots may be in terracotta, metal, or concrete, and exist in different shapes: square, round, perforated, etc., adapted to the building architecture. It is therefore a traditional piece of equipment present in all cities with different color and shape, and consequently very commonplace in urban environments, even in protected areas, because installed on traditional chimneys, by definition elevated and sufficiently clear to allow enough air flow to ensure the draft of the chimney duct that it terminates.

As an optional addition, said volume of the radiofrequency device 10 (that is, less than 15 L) is contained in a cylinder 24 cm in diameter and 60 cm in height. In other words, the diameter of the radiofrequency device is less than 24 cm while still having a volume less than 15 liters. Likewise, its height does not exceed 60 cm, while still presenting a volume less than 15 liters.

Indeed, existing chimney pots present dimensions the maximum volume of which is defined, for example in France, by the “Lorientais chimney pot” the volume of which is substantially equal to or is contained in a cylinder 24 cm in diameter and 60 cm in height.

According to another example, the standard-size Parisian chimney pot is typically 19 cm in diameter and 30 to 50 cm high.

As an optional addition, the maximum weight of said radiofrequency device 10 is substantially equal to 12 kg (that is, kilograms). Such a weight of the radiofrequency device 10 is indeed most of the time supportable by the roof T elements of a building and corresponds for example to the maximum weight of a chimney pot used in France, namely that of the “Charentais chimney pot”.

In the example of FIG. 1, said cover comprises at least two openings 14 (that is, air intakes) the arrangement of which relative to each other is configured to circulate air within said enclosure, and thus naturally ventilate said radiofrequency assembly of said radiofrequency device 10.

In the example of FIG. 1, such openings 14 are provided in the lateral wall of the cylinder.

In addition, or as an alternative, said at least two openings 14 are located at the vertical ends of said cover 12. In other words, the openings are located at the base and the top of the cover so as to allow vertical ventilation from the top and bottom of the radiofrequency device 10 according to the present invention.

As an optional addition, said cover 12 is configured to be secured to a building chimney stack or to a chimney or ventilation duct.

Such a location of said radiofrequency device 10 is advantageous because, by thus having sufficient clearance relative to the roof, it is able to avoid the “terrace effect” which would limit its radio coverage and performance by generating masking or unwanted reflections. More precisely, it is sought, according to the present invention, to install said radiofrequency device 10 either at the edge of the roof or sufficiently high to avoid the “terrace effect”, which consists of having nearby obstacles that prevent the RF signal from propagating, which limits the radiation of the antenna of the radiofrequency device 10 in certain directions (especially downward while mobile phones are precisely often below relative to the radiofrequency device 10). The “terrace effect” is notably addressed in the document, which is incorporated by reference herein and accessible via the following URL link:
www.hypercable.fr/images/stories/wirake/Installation_des_antennes_V.2.pdf.

According to one alternative, the cover 12 is, as such, a building roof chimney pot. In other words, in this case the radiofrequency device 10 is directly secured to an existing chimney or ventilation duct. In this respect, the shape of said cover 12 is able to be adapted depending on its geographical location so as to integrate perfectly (that is, blend) into the landscape of urban roofs in the geographical area in which the associated radio site is deployed.

Such an alternative technically allows to directly reuse an existing installation infrastructure and, where appropriate, notably when said existing chimney or ventilation duct is no longer used for its original function of chimney or ventilation duct, to reuse it to pass a power supply cable 16 for said radiofrequency device 10.

Said power supply cable 16 is then advantageously invisible on the roof and protected from bad weather and vandalism within said chimney or ventilation duct, decommissioned from its original function, which allows to limit associated maintenance and the risks of water infiltration into the roof.

It should be noted that the radiofrequency device 10 according to the present invention, due to its compact volume, is able to facilitate its technical installation on a roof, including at a location distinct from that facing a chimney or ventilation duct, notably when said chimney or ventilation duct is still used according to its original function.

As an optional addition, said radiofrequency device further comprises at least one connection port configured to connect, by optical fiber 18, said radiofrequency assembly to a passive optical network.

According to one alternative of this optional addition, said passive optical network is a fiber-to-the-home FTTH optical fiber network (from the English Fiber to the Home). The radiofrequency device 10 is then connected with a fiber 18 preferably to the optical branching point PBO typically located in the building, as a household can be connected to the FTTH network, or otherwise directly to the mutualization point PM typically located in the street.

It should be noted that when said cover 12 is, as such, a building roof chimney pot (that is, directly secured to an existing chimney or ventilation duct), such an alternative technically allows to directly reuse an existing installation infrastructure and, where appropriate, notably when said existing chimney or ventilation duct is no longer used for its original function of chimney or ventilation duct, to reuse it also to pass said fiber 18.

Indeed, a difficulty in radio site deployment is access to the information transport network (that is, the feedback, from the English transmission backhauling), base stations currently being connected via wireless links or by dedicated fiber, at least over the last kilometer, and the present invention proposes to remedy this difficulty by using the existing FTTH fiber-to-the-home optical fiber network to ensure the information transport of each radiofrequency device used, which allows to reduce the complexity and the cost associated with current information transport.

In FIG. 1, due to the opaque cover 12 (that is, visually), the internal structure of the radiofrequency device 10 is invisible from the outside.

FIG. 2 is an overall schematic representation of an example 20 of a radiofrequency device of a telecommunications network according to the present invention and aims to illustrate its internal structure in more detail.

More precisely, inside the cover 22 neutral (that is, transparent) to electromagnetic waves, the radiofrequency device according to this example 20 comprises a radiofrequency assembly 24, not mechanically ventilated, but by natural convection in order to advantageously avoid noise nuisance linked to vibrations that could disturb local residents by propagating in the building structure or more particularly in chimney ducts, where appropriate reused for the cabling of the radiofrequency device 10. It should be noted that the absence of mechanical ventilation requires a predetermined minimum volume for heat dissipation by natural convection; however, according to the present invention, the dimensions of said cover 22 remain advantageous also in accordance with the selected volume range, namely less than (or even strictly less than) fifteen liters.

According to an optional aspect, the cover 22 of the radiofrequency device 20 presents notably a protection rating equal to IP65, namely dust-tight and able to protect against water projections, and compliance with seismic standards for zone 4.

This radiofrequency assembly 24 comprises a radiofrequency module composed, in the example of FIG. 2, of a radiating part 26, such as a heat sink, associated with a digital and analog board 28.

Such a radiating part 26 radiates the heat produced by the digital and analog board 28, said heat itself being dissipated by natural convection.

The openings 14 mentioned above in relation to FIG. 1 of said cover 22, namely according to the embodiment of FIG. 2 located at the vertical ends of said cover 22, indeed allow to ventilate said radiofrequency assembly 24 so as to evacuate the heat generated by the radiating part 26 associated with said digital and analog board 28, and thus avoid overheating of these components.

Said radiofrequency assembly 24 further comprises an antenna system 30 comprising for example, according to the diagram of FIG. 2, an antenna composed of two distinct dipoles 32.

According to the present invention, said radiofrequency assembly 24 is specifically configured so that its total equivalent isotropic radiated power is greater than (or even strictly greater than) fifty-five dBmi.

To this end, according to one possible configuration, each antenna presents a gain of 13 dBi, is able to transmit over a 120° sector with a beamwidth of the order of 65° at -3 dB.

According to an optional addition, not represented, said radiofrequency device 20 according to the present invention, presents an indicator representative of the direction of its transmission beam.

Furthermore, said radiofrequency module comprises within its digital and analog board 28 a plurality of amplifiers the power of which is adapted so that the total equivalent isotropic radiated power is greater than (or even strictly greater than) fifty-five dBmi.

It should be noted that the configuration of this digital and analog board 28 is not obvious because its size is limited by the volume of said radiofrequency device 10, namely less than (or even strictly less than) a predetermined volume threshold equal to 15 L (that is, fifteen liters), the components of this radiofrequency digital and analog board therefore being judiciously chosen, as well as its arrangement with the radiating part 26 within the cover 22.

According to one advantageous alternative of the present invention, said arrangement is optimized so that the volumetric occupancy of the radiofrequency assembly 24 is maximum within the cover 22. In other words, if one considers that the cover 22 is substantially cylindrical in shape, according to this advantageous alternative, the radiating part 26 presents a shape configured to, according to a sectional view (that is, in cross-section, slice) of the cylindrical cover, follow as closely as possible (that is, substantially match) the curvature of the cylindrical cover 22 in which it is arranged.

To this end, the radiating part 26 is for example configured to be contained in a half-cylinder the rectangular face of which faces said digital and analog board 28, while its rounded outer lateral surface faces the rounded inner lateral surface of the cylindrical cylinder 22. According to this example, the radiating part 26 comprises for example a plurality of fins, which according to said section extend according to directions corresponding to distinct radii of said half-cylinder, or parallel to one another according to a direction perpendicular to said rectangular face facing said digital and analog board 28.

Such a configuration of the radiating part 26 advantageously allows to maximize heat exchange with the wall of the cover 22.

Other configurations of radiating parts are able to be used, such as a configuration where the radiating part 26 presents a substantially parallelepiped shape the right angles of which are for example optionally rounded to partially follow as closely as possible the curvature of the cylindrical cover 22 in which it is arranged.

According to one example, these components are in accordance with 3GPP standards and are able to implement TDD and/or FDD multiplexing, for transmitting in band n78, and more precisely in the frequency range from 3400 to 3800 MHz with an instantaneous bandwidth IBW (Instantaneous Bandwidth) of the order of 400 MHz, and an occupied bandwidth OBW (Occupied Bandwidth) of 100 MHz, and according to 5G standards.

These components are able to support, on the downlink, a quadrature amplitude modulation such as up to at most 256QAM, and on the uplink, a quadrature amplitude modulation such as up to at most 64QAM.

To satisfy the requirement of total equivalent isotropic radiated power greater than (or even strictly greater than) fifty-five dBmi, depending on the chosen antenna system 30, said digital and analog board is able to comprise a plurality of amplification chains.

By way of example, according to a first configuration, the digital and analog electronic board comprises for example 4 chains dedicated to transmission and reception, that is, a so-called “4T4R” configuration, the maximum output power per chain being, for example, 15 W that is, 60 W total, that is, 48 dBm, associated with an antenna the gain of which is 13 dBi, that is, a total EIRP of 61 dBmi, which is well above 55 dBmi. The radiofrequency assembly 24 corresponding to this first configuration, formed by the antenna system 30 and the radiofrequency module, itself composed of the radiating part 26 and the digital and analog board 28, presents a volume of eleven liters, and the cover 22 presents a diameter of 19 cm and a height of 50 cm, that is, a total volume of 14.18 liters.

More precisely in this example of a first configuration, according to a cross-sectional view (that is, slice) according to the height of the substantially cylindrical cover 22 with a diameter of 19 cm, the assembly formed by the digital and analog electronic board 28 and the antenna system corresponds substantially to a rectangle of 1.24 dm² (that is, length equal to 17 cm and width equal to 7.3 cm) inscribed in the circle of 19 cm diameter (that is, area equal to 2.83529 dm²) of the cover 22. The radiating part 26 presents a half-circle shape (according to the cross-section and as a half-cylinder in volume) such described above, and a half-circle area of 1.01 dm², the base of the half-circle facing the width of said rectangle.

Thus, according to the slice, the radiofrequency assembly 24 occupies a cumulative surface area of 2.25 dm², its height being 4.9 dm, one indeed obtains a volume of about 11 liters (11.025 liters) which occupies 77.75 % of the volume of the cover 22.

By way of example, according to a second configuration, the digital and analog electronic board comprises for example 8 chains dedicated to transmission and reception, that is, a so-called “8T8R” configuration, the maximum output power per chain being, for example, 7 W that is, 56 W total, that is, 47.48 dBm, associated with an antenna the gain of which is 13 dBi, that is, a total EIRP of 60.48 dBmi, which is well above 55 dBmi. The radiofrequency assembly 24 corresponding to this configuration, formed by the antenna system 30 and the radiofrequency module, itself composed of the radiating part 26, for example of parallelepiped shape, associated with the digital and analog board 28 (12 cm by 48 cm), presents a volume of 11 cm x 15 cm x 49 cm, that is, 8.09 liters, and the corresponding cover 22 presents a diameter of 19 cm and a height of 50 cm that is, a total volume of 14.18 liters.

Any other configuration (that is, arrangement) in accordance with the selected volume and EIRP chosen is able to be implemented according to the present invention.

Such a radiofrequency device 20 is able to be powered via an AC supply voltage between 76 and 228 VAC. The maximum consumed power is, for example, 250 W, typically 200 W.

Optionally, the radiofrequency device 20 comprises a backup battery the autonomy of which is of the order of one hour, in order to protect the radiofrequency device 20 from short outages related to the electrical network.

As an optional addition, said radiofrequency device further comprises a global navigation satellite system GNSS module (from the English Global Navigation Satellite System).

The GNSS module is an electronic component advantageously used according to this optional addition to determine the precise geographical position of the radiofrequency device, using signals coming from satellites orbiting the Earth. GNSS systems include technologies such as GPS (Global Positioning System) of the United States, GLONASS of Russia, Galileo of the European Union, and BeiDou of China. It is also used to determine the orientation of the radiofrequency device in the horizontal plane (that is, in azimuth).

It should be noted that due to its “outdoor” nature, the radiofrequency device 20 according to the present invention is configured to operate from -40° C to +55° C, and to be stored at a temperature between -40° C and +70° C.

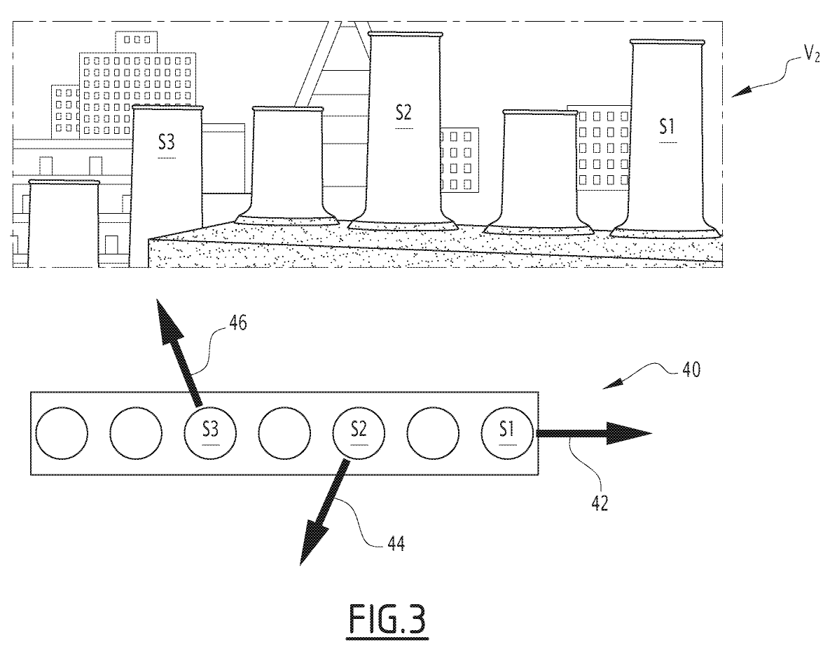

FIG. 3 is a schematic representation of an example implementation of a radiofrequency system 40 for a telecommunications network configured to be installed on a building roof as illustrated by view V₂ of FIG. 3.

Indeed, the present invention also relates to such a radiofrequency system 40 for a telecommunications network which comprises at least two radiofrequency devices as previously described.

According to the embodiment of FIG. 3, said radiofrequency system comprises at least three radiofrequency devices S₁, S₂, and S₃ each configured to transmit respectively in three distinct transmission sectors represented respectively by their transmission direction, namely according to the sector direction 42 for the radiofrequency device S₁, according to the sector direction 44 for the radiofrequency device S₂, and according to the sector direction 46 for the radiofrequency device S₃.

Thus, via this combination of radiofrequency devices according to the present invention, the resulting radiofrequency system behaves like a Mini Macro radio site able to cover three distinct angular transmission sectors so as to provide for example a global coverage of 3x120°=360°.

As an alternative and/or as an optional addition, according to another embodiment, said system comprises at least two radiofrequency devices according to the present invention configured to transmit in combination within a same transmission sector.

Indeed, obtaining a radiofrequency device in accordance with the specific combination mentioned above of volume range and EIRP [dBmi] range is challenging due to the fact that its equivalent isotropic radiated power capability is limited by the said available volume, and to further improve the overall performance of the system, notably per sector, it is proposed to combine at least two radiofrequency devices within the same sector.

Thus, by taking one of the previous configurations of a radiofrequency device based on the use of at least 4 transmit-receive chains, for example MIMO, within said radiofrequency device, it is proposed to increase the transmit-receive capacity per sector by using at least two radiofrequency devices, that is, 8 MIMO chains, via said two radiofrequency devices deployed with the same azimuth in order to cover the same sector.

More precisely, according to the present invention, it has been determined by calculation that three radiofrequency devices, in accordance with the selected volume and total equivalent isotropic radiated power ranges, and combined within a same sector, are able to increase the transmit-receive capacity of this sector relative to a conventional outdoor transmit-receive device.

Indeed, by calculation, the inventors have demonstrated that a radiofrequency system with three sites, each equipped with three radiofrequency devices (one per sector), that is, nine radiofrequency devices in total, provides the same coverage in a very dense urban area as well as the same capacity as a “macro” radio site with three sectors of 3x120°=360°, with three traditional “macro” devices, while presenting a cumulative volume (that is, sum of the volume of the nine radiofrequency devices) more than seven times lower.

According to one optional alternative of this embodiment based on a plurality of radiofrequency devices per sector (even in the same cell), said system comprises a module configured to multiplex the signals transmitted by said at least two radiofrequency devices in the same azimuth.

Said multiplexing module is notably integrated within a distributed unit DU (Distributed Unit) or centralized CU (Central Unit) to manage the signals coming from the at least two radiofrequency devices associated with the same sector, so that they are perceived as coming from the same cell, and this by implementing relevant signal processing able to ensure, for example, multi-user MIMO operation and high-performance beamforming. Such management, within a same time interval (time slot), allows said distributed or centralized unit to multiplex several users simultaneously, which allows to at least double the maximum processing capacity of a cell and to reduce the gap with “macro” radiofrequency products according to the prior art.

The person skilled in the art will understand that the invention is not limited to the embodiments described, nor to the particular examples of the description, the embodiments and alternatives mentioned above being able to be combined with each other to generate new embodiments of the invention.

The present invention thus allows, by selecting the specific combination mentioned above of the volume range of said radiofrequency device and the total EIRP [dBmi] range, to propose a radiofrequency device allowing the implementation of a “mini-macro” radio cell, namely a radio site mini in size in view of the current sizes of radio sites equivalent in performance, and therefore easy to install on a roof, while being sufficiently high-performing to form, in combination with a plurality of other radiofrequency devices according to the present invention, a radiofrequency system the operation of which corresponds to that of a macro-cell.

It should be noted that when, optionally, the cover of the radiofrequency device is directly a building roof chimney pot, then the present invention allows to reuse the existing infrastructure, chimneys already being present on the roof and able to support a radiofrequency device according to the present invention.

In addition to the technical advantages mentioned above, the present invention also indirectly allows to address other administrative and regulatory considerations. Traditionally, the installation of a radio site according to the prior art is indeed subject to obtaining authorization(s), or even building permits, requires compliance with local regulations or urban planning standards, certain localities imposing restrictions on antenna installation for aesthetic or heritage reasons, or must face opposition from local residents, fear of electromagnetic waves often leading to appeals and delays.

The volume of each radiofrequency device proposed according to the present invention is able to allow these administrative or regulatory constraints to be bypassed because it is able to substitute a building roof chimney pot.

The present invention also indirectly allows to address other economic considerations; indeed, in terms of cost, installation of a conventional radio site costs between €100,000 and €200,000, or even more depending on complexity, due to the infrastructures to be deployed and complex installations; the cost of the telecommunications equipment of these traditional installations being high because they are generally formed of complex products.

The present invention provides a radiofrequency device with lower economic constraints because it is powered with just two cables for electrical power and for fiber respectively, with natural convection in order to advantageously avoid noise nuisance linked to vibrations that could disturb local residents by propagating in the building structure and presenting a compact and simplified design within a cover able to substitute a building roof chimney pot.

Finally, by having a volume able to substitute a building roof chimney pot, an element often existing in the landscape, the present invention also indirectly allows to address other environmental and societal considerations.

Indeed, the installation of a radio site according to the prior art runs up against:
the need to protect natural/urban spaces limiting the implantation options notably in natural parks or protected areas, where constraints are stricter,
problems of social acceptability, citizen groups sometimes opposing new installations, slowing down projects,
the need for landscape integration for social acceptability, via a fake tree, a fake floor on a building, etc.,
and must comply with the local urban plan (PLU) or obtain the approval of an Architect of the Buildings of France for example.

By having a volume able to substitute a building roof chimney pot, the proposed radiofrequency device meets such environmental and societal constraints, because a chimney pot is already known in the landscape; the product therefore does not degrade the visual appearance of buildings, complies with PLUs because chimneys are necessarily authorized or pre-existing, likewise the requirements of the Architects of the Buildings of France for example.

The present invention therefore allows to greatly simplify the deployment of radio equipment and to be installed in all environments, even those currently impossible.

1. A radiofrequency device of a telecommunications network, said radiofrequency device being able to transmit and receive outdoor radiofrequency signals, configured to be installed on a building roof, and comprising at least:
a radiofrequency assembly, with natural convection, comprising an antenna system and a radiofrequency module,
an electrical power supply module for said radiofrequency assembly;
a cover transparent to electromagnetic waves forming an opaque enclosure around said radiofrequency assembly,
wherein the volume of said radiofrequency device is less than a predetermined volume threshold equal to fifteen liters and in that its total equivalent isotropic radiated power is greater than fifty-five dBmi.

2. The radiofrequency device according to claim 1, wherein said volume is contained in a cylinder 24 cm in diameter and 60 cm in height.

3. The radiofrequency device according to claim 1, wherein the maximum weight of said radiofrequency device is substantially equal to 12 kg.

4. The radiofrequency device according to claim 1, wherein said cover comprises at least two openings the arrangement of which one relative to the other is configured to circulate air within said enclosure.

5. The radiofrequency device according to claim 4, wherein said at least two openings are located at the vertical ends of said cover.

6. The radiofrequency device according to claim 1, wherein said radiofrequency device presents an indicator representative of the direction of its transmission beam.

7. The radiofrequency device according to claim 1, wherein said cover is configured to be secured to a building chimney stack or to a chimney or ventilation duct.

8. The radiofrequency device according to claim 7, wherein said cover is configured to substitute a building roof chimney pot.

9. The radiofrequency device according to claim 1, wherein said radiofrequency device further comprises at least one connection port configured to connect, by optical fiber, said radiofrequency assembly to a passive optical network.

10. The radiofrequency device according to claim 9, wherein said passive optical network is a fiber-to-the-home FTTH optical fiber network.

11. The radiofrequency device according to claim 1, wherein said radiofrequency device further comprises an internal GNSS module in the device.

12. A radiofrequency system for a telecommunications network configured to be installed on a building roof wherein the radiofrequency system comprises at least two of the radiofrequency devices according to claim 1.

13. The radiofrequency system according to claim 12, wherein said at least two radiofrequency devices are configured to transmit in combination in a same transmission sector.

14. The radiofrequency system according to claim 13, further comprising a module configured to multiplex the signals transmitted by said at least two radiofrequency devices in the same azimuth.

15. The radiofrequency system according to claim 12, comprising at least three of the radiofrequency devices configured to transmit respectively in three distinct transmission sectors.
